(19) United States
(12) Patent Application Publication
(10) Pub. No.: US 2007/0051230 A1
(43) Pub. Date: Mar. 8, 2007

(54) Information processing system and information processing method

(76) Inventor: Takashi Hasegawa, London (GB)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/515,906

(22) Filed: Sep. 6, 2006

(30) Foreign Application Priority Data
Sep. 6, 2005 (JP) JP 2005-257238

(51) Int. Cl. G10H 7/00

(52) U.S. Cl. 84/616

(57) ABSTRACT

An information processing system and method extract the pitch sequence feature information and the temporal volume change regularity feature information from two music contents to determine whether a music is involved or not. As for the portion determined as a music, the information are compared with the intermediate portion thereby to determine the identity of the music in the contents. Also, by determining the identity with the contents on the data base configured of a plurality of accumulated music contents and thereby determining which music in the data base is coincident, the music in the contents is identified and retrieved.

### INCORPORATION BY REFERENCE

The present application claims priority from Japanese application JP 2005-257238 filed on Sep. 6, 2005, the content of which is hereby incorporated by reference into this application.

### BACKGROUND OF THE INVENTION

This invention relates to an information processing system, an information processing method and a program for retrieving a sound similar to another second using the feature information of the another sound.

A conventional method has been conceived in which a given music is retrieved by determining the pitch and the volume of the particular music and configuring a logic formula including the ambiguity from the pitch and the volume (JP-A-2001-52004: Patent Document 1).

A conventional method has also been conceived in which a first music content is replaced by a second music content by using an index manually added to a music as a search key or the feature amount of the music head (JP-A-2004-134010: Patent Document 2).

### SUMMARY OF THE INVENTION

In Patent Document 1, however, the retrieval is based on pitch and volume, and therefore a music of which the pitch is difficult to detect (such as the rap music) cannot be accurately retrieved. In the case where the music associated with the search key and the music making up the data base are different in tempo (live image and CD image, for example), the retrieval accuracy is varied with the ambiguity designated by the user on the one hand and the user is required to input an appropriate value on the other hand, thereby leading to an insufficient operating convenience.

In Patent Document 2, on the other hand, an index manually assigned to a music or the feature amount of the music head is used as a search key. In the case where a voice or a hand clapping is mixed in the music head of a music program, therefore, the retrieval of high accuracy is impossible, thereby resulting in an insufficient operating convenience.

This invention has been developed in view of the situation described above, and the object of the invention is to improve the operating convenience in the sound retrieval.

In order to achieve the object described above, according to this invention, there is provided an information processing system comprising an input unit for inputting the data including audio data, an extraction means for extracting the feature information including the pitch sequence information and the temporal volume change regularity information from the audio data input by the input unit, and a determining means for determining the analogy degree between the feature information extracted by the extraction means and the feature information of a predetermined audio data.

Also, the pitch sequence information constituting the feature information for determining the analogy degree of the audio data is normalized by the normalized temporal volume change regularity information. As a result, the analogy degree of the audio data different in tempo can also be accurately determined.

The information processing system according to the invention further comprises a music determining means for determining whether a predetermined portion of the audio data is a music or not based on the extracted feature information. Even in the case where a voice or a hand clapping is mixed in the music head, therefore, the analogy degree of the audio data can be determined with high accuracy.

According to this invention, the operating convenience for the sound retrieval can be improved.

### BRIEF DESCRIPTION OF THE DRAWINGS

These and other features, objects and advantages of the present invention will become more apparent from the following description when taken in conjunction with the accompanying drawings, wherein:

FIG. 1 shows an example of a music identity determining method;

FIG. 2 shows an example of the pitch sequence feature amount extraction process;

FIG. 3 shows an example of the calculation formula for the pitch frequency, the power of the musical scale and the sound power;

FIG. 4 shows an example of the process of extracting the temporal volume change regularity;

FIG. 5 shows an example of the analogy degree calculation process;

FIG. 6 shows an example of the calculation formulae of the temporal volume change regularity analogy degree, the normalized pitch sequence, the pitch sequence analogy and the degree of analogy;

FIG. 7 shows an example of the condition for determining the non-music portion;

FIG. 8 is a schematic diagram showing an example of the contents including the non-music portion and the music contents;

FIG. 9 shows an example of the music related information retrieval system;

FIG. 10 shows an example of the music related information retrieval;

FIG. 11 shows another example of the music data base in FIG. 9;

FIG. 12 shows another example of the music identity determining method;

FIG. 13 shows an example of the music information value adding system;

FIG. 14 shows an example of the music information value adding method;

FIG. 15 shows an example of the temporal volume change regularity correction amount;

FIG. 16 shows an example of the TV or a hard disk/DVD recorder according to this invention; and

FIG. 17 shows an example of a feature generating unit for the music data base.

### DESCRIPTION OF THE EMBODIMENTS

An embodiment of the invention is explained below with reference to the drawings.

A method of determining the music identity of contents according to an embodiment of the invention is explained below with reference to FIG. 1.

First, the temporal change regularity of pitch sequence and volume (103, 113) are extracted from the sound in two video contents or sound contents (101, 111) by a feature extraction process (102, 112). Next, the extracted feature amounts (103, 113) are compared with each other and the identity (121) of the two contents (101, 111) is determined by an analogy degree calculation process (120). The pitch sequence is a list of power values for the frequency having the sound announced at a given time or a code string encoded according to a specified rule from the power values.

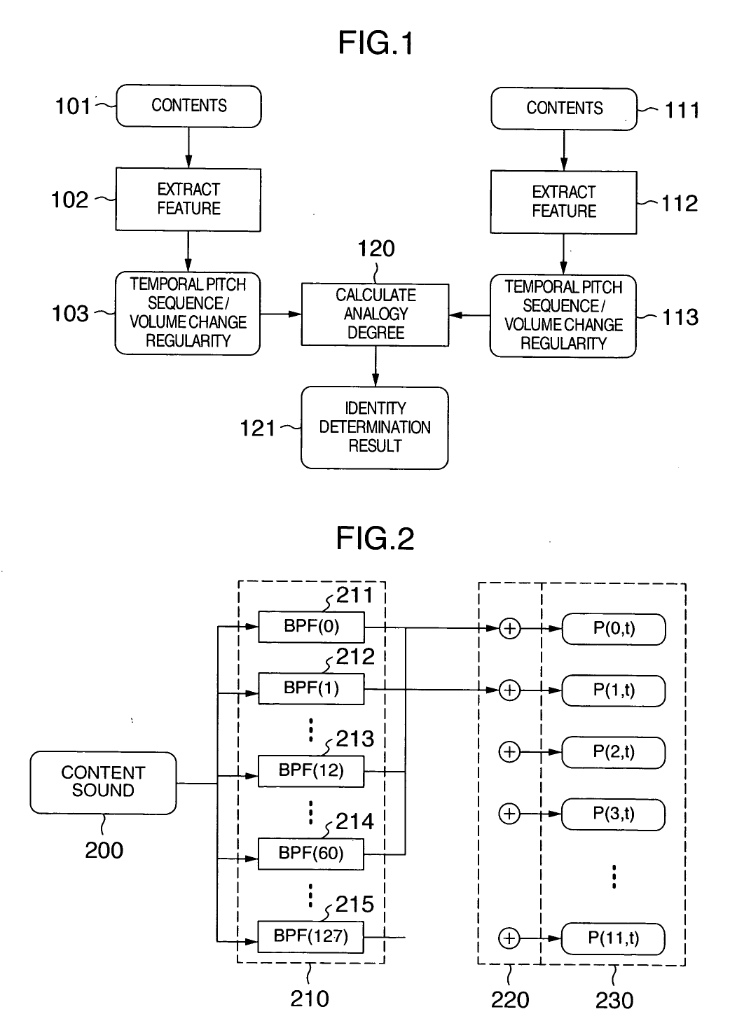

Next, the feature extraction process (102, 112) shown in FIG. 1 according to an embodiment is explained with reference to FIGS. 2 to 4.

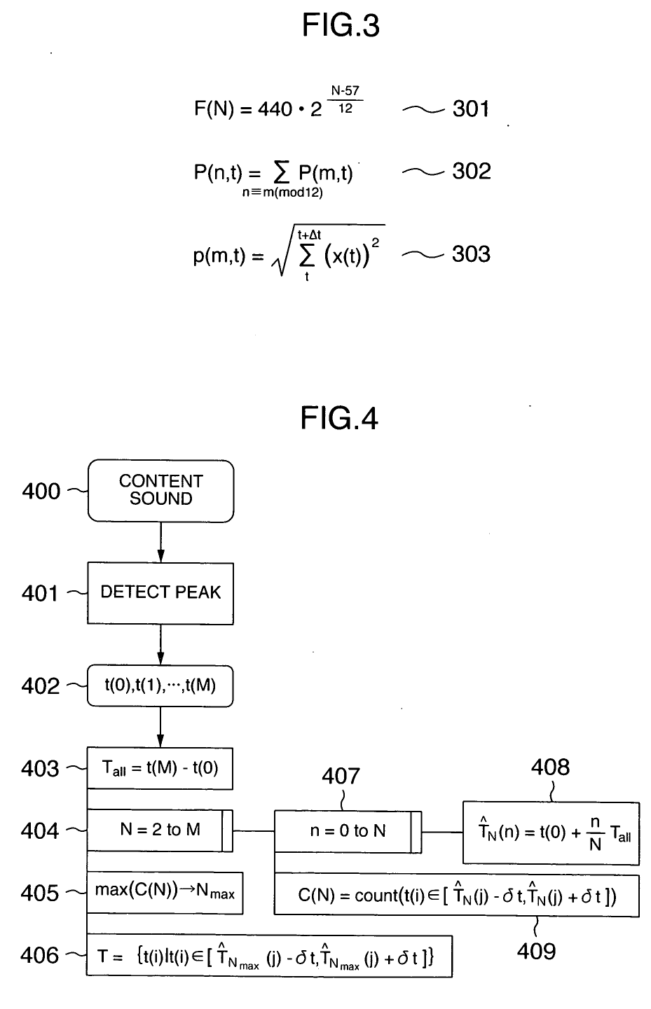

First, the pitch sequence extraction process is explained with reference to FIGS. 2 and 3.

The sound information (200) of the contents is input to a filter bank (210). The filter bank (210) is configured of 128 bandpass filters (BPF: 211 to 215), each a filter having a peak frequency of pitches 0 to 127. The pitch corresponds to the half musical scale with the center C sound of the 88-key piano as 60 (214). The pitch 0 (211), for example, is the C sound five octaves lower than the center C, the pitch 1 (212) the C# sound, the pitch 12 (213) the C sound four octaves lower than the center C, and the pitch 127 (215) the G# sound above the C sound five octaves higher than the center C. The frequency F(N) of the pitch N is expressed by 301. The sound that has passed through a BPF has only the frequency F(N) corresponding to the pitch N of the particular BPF and the neighboring frequency components.

Next, the sound of the same musical scale passed through the BPF are added to each other to determine the power for each musical scale (220). The power of the musical scale C, for example, is the sum of power of the pitches of C sound at each octave, i.e. 0, 12, 24, 36, 48, 60, 72, 84, 96, 108, 120. In this case, the power P (n, t) of the musical scale n at time t can be determined using equation 302 from the power p (m, t) of BPF (m) at the same time point. Also, the power of the BPF can be determined using equation 303 from the output x(t) to x(t+Δt) of the BPF around the particular time.

The 12-dimensional vector amount, i.e. P (n, t) (230) for each time determined from the aforementioned process is a pitch sequence.

Next, the process of extracting the temporal volume change regularity is explained with reference to FIG. 4. First, a peak string (402) is determined by the peak detection process (401) from the sound information (400) of the contents. Specifically, the power of the content sound is determined by a method according to equation 303, and the time when the local maximum value of the power exceeds a predetermined value is set as a peak, which is used as an element of the peak string.

The time between the first peak and the last peak is determined (403), and divided into equidistant parts equal to 2 to the number of peaks (404), followed by executing the process described below. Assume that the time between the first to last peaks is divided into N parts. The actual number of peaks existing in the neighborhood of each (407) of the estimated peak positions (408) is determined (409). The number of divisions for which the greatest number of actual peaks exist in the neighborhood of the estimated peak position are determined (405), and the mass configured of only the peaks existing in the neighborhood of the positions equally divided into the particular number of divisions is defined as a temporal volume change regularity T (406).

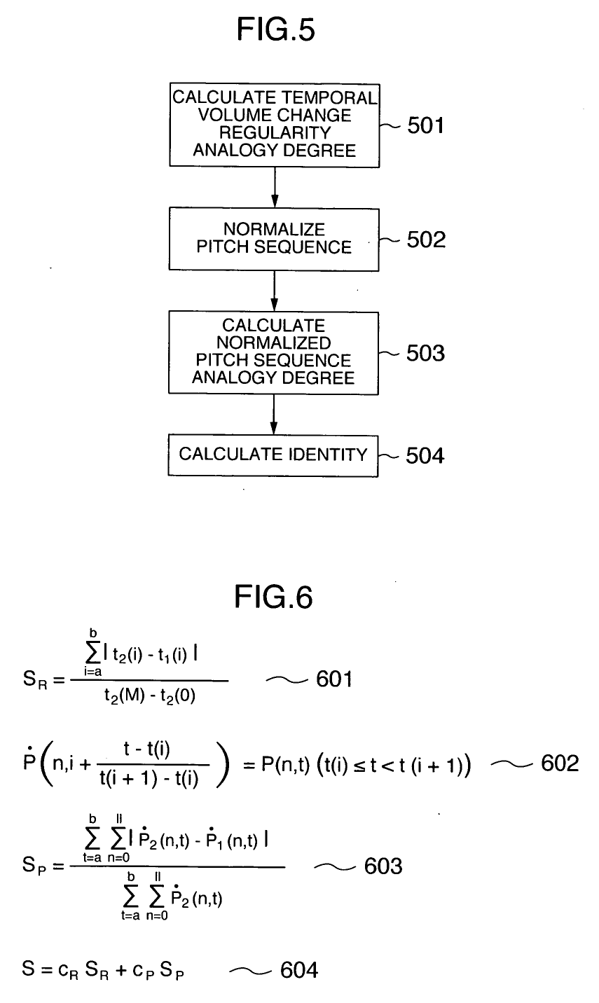

Next, the analogy degree calculation process (120) shown in FIG. 1 is explained with reference to FIGS. 5 and 6.

First, the analogy degree of the temporal volume change regularity of two contents is calculated (501). Next, the pitch sequence of each content is normalized using the temporal volume change regularity (502). The analogy degree of the normalized pitch sequence is calculated (503), and the identity is calculated from the temporal volume change regularity analogy degree and the normalized pitch sequence analogy degree (504).

The temporal volume change regularity analogy degree is expressed by equation 601. The lower right number affixed to t indicates the content 1 or 2, a and b a constant between 0 and M indicating that only the temporal volume change regularity for the intermediate portion of the contents is used. This is by reason of the fact that in the case of sound information such as a music program or a live concert, the sound such as the clapping or announcement is superposed at the start or end of a content, which is a factor contributing to the reduction in the accuracy of analogy degree calculation.

Next, the normalized pitch sequence is converted as indicated by equation 602. In this pitch sequence, the time between peaks of the temporal volume change regularity is normalized to 1. As a result, the identify can be determined even in spite of a difference in tempo which may exist between the contents to be compared. Further, the normalized pitch sequence analogy degree is determined by equation 603. The meaning of each symbol is similar to that of equation 601. The identity S is determined by linear coupling of the aforementioned two analogy degrees (604).

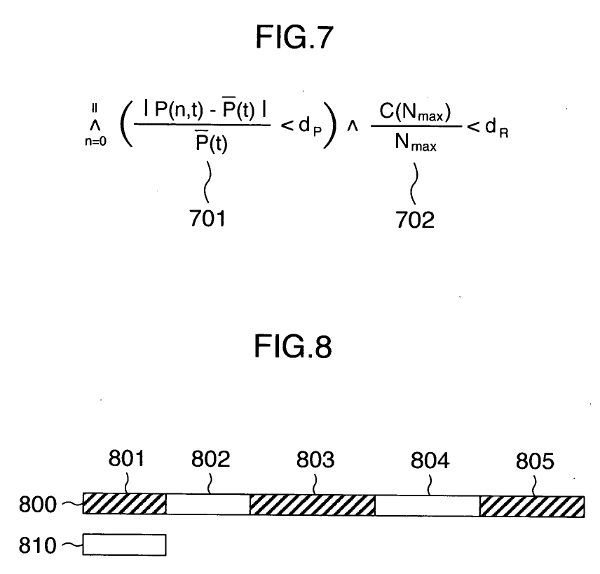

In the case where one of the contents of which identity is to be determined is a music program or a live concert with a mixture of a music and a portion other than the music, the non-music portion is detected at the time of feature extraction (102 in FIG. 1) and the identity determined only for the music portion. A method of determining the identity with the content including a non-music portion is explained with reference to FIGS. 7 and 8.

FIG. 7 is the condition for determining the non-music portion. The left term (701) is the determination condition for the pitch sequence, and the right term (702) the determination condition for the temporal volume change regularity. In the case where these two determinations are both true, the time t is determined as a non-music portion. The left term (701) indicates that the difference between the power and the average power of each musical scale is always less than a predetermined value, in which case the sound lacks the musical scale, resulting in a non-music candidate. The right term (702), on the other hand, indicates that the actual number of existent peaks, as compared with an estimated number of peak positions, is smaller than a predetermined value, in which case the rhythmical sense is lacking, resulting in a non-music candidate. The condition shown in FIG. 7 shows that the sound lacking the sense of both musical scale and rhythm is a non-music sound.

In FIG. 8, for example, assume that the identity of the content 1 (800) and the content 2 (810) is to be determined and that the non-music portions of the content 1 (800) are determined as 801, 803, 805 according to the condition shown in FIG. 7. The identity is determined between 802 and 810 and between 804 and 810.

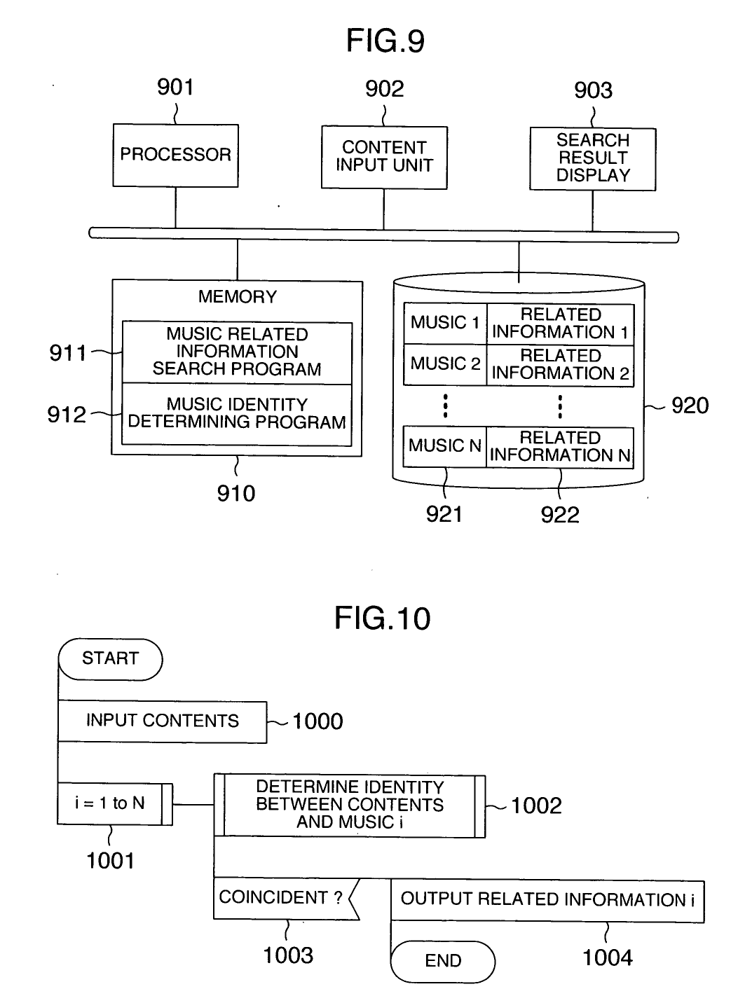

Next, a music search system and method using the aforementioned music identity method are explained with reference to FIGS. 9 and 10.

This music search system is configured of a processor (901) for executing the search, a unit (902) for inputting the retrieved contents, a unit (903) for displaying the search result and implementing a user interface, a memory (910) for storing the program or temporarily holding the ongoing process and a music data base (920). The content input unit (902) may be a storage device such as a hard disk or a DVD, a network connection unit for inputting the contents accumulated on a network, or a camera or a microphone for inputting an image or a sound directly. Also, the memory (910) has stored therein a music related information search program (911) and a music identity determining program (912). The music data base, on the other hand, has stored therein a plurality of music (921) and the related information (922) such as the title, player and the composer of each music.

In music search, the first step is to start the music related information search program (911) from the memory (910) and the processor (901) executes the process described below. The contents are input (1000) from the content input unit (902). Next, the identity of the content and each (1001) of the music (921) on the music data base (920) is determined (1002) using the music identity determining program (912). In the case where the music i is successfully identified (1003), the value corresponding to i is output (1004) from the related information (922) to the search result display unit (903).

In 1004, the music i itself may be output in place of the related information as a search result. Consider a case, for example, in which the same music as played in a music program is heard with CD quality. In such a case, the related information (922) is not required.

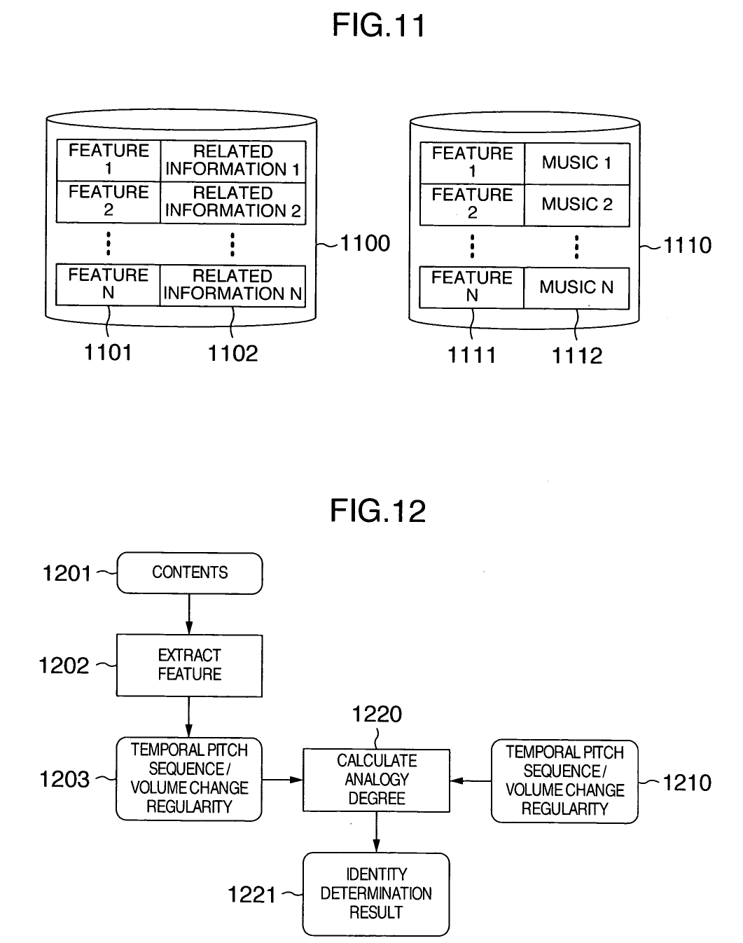

In retrieving the related information, the feature information may be extracted in advance from the music (921) on the music data base (920) and stored in the same data base. In such a case, the music data base, as shown by 1100 in FIG. 11, is configured of the feature (1101) extracted from the music and the related information (1102). Also in the case where the music itself is output as a search result, the feature information may be similarly extracted in advance. In such a case, the data base is configured of the feature (1111) and the music (1112) as indicated by 1110.

The identity determining process in this case is explained with reference to FIG. 12.

First, the feature amount (1203) is extracted from the retrieved content (1201) by the feature extraction process (1202). Next, in the analogy degree calculation process (1220), the extracted feature amount (1203) is compared with the feature amount (1210) accumulated in the data base (1100 or 1110) thereby to determine the identity (1221) with the music in the data base.

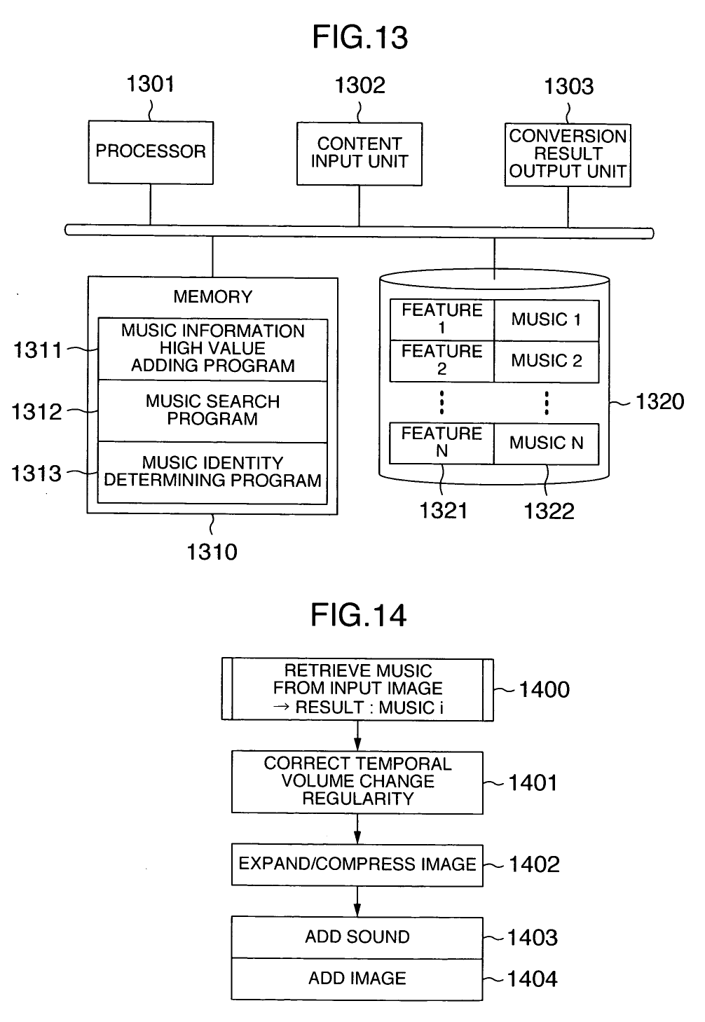

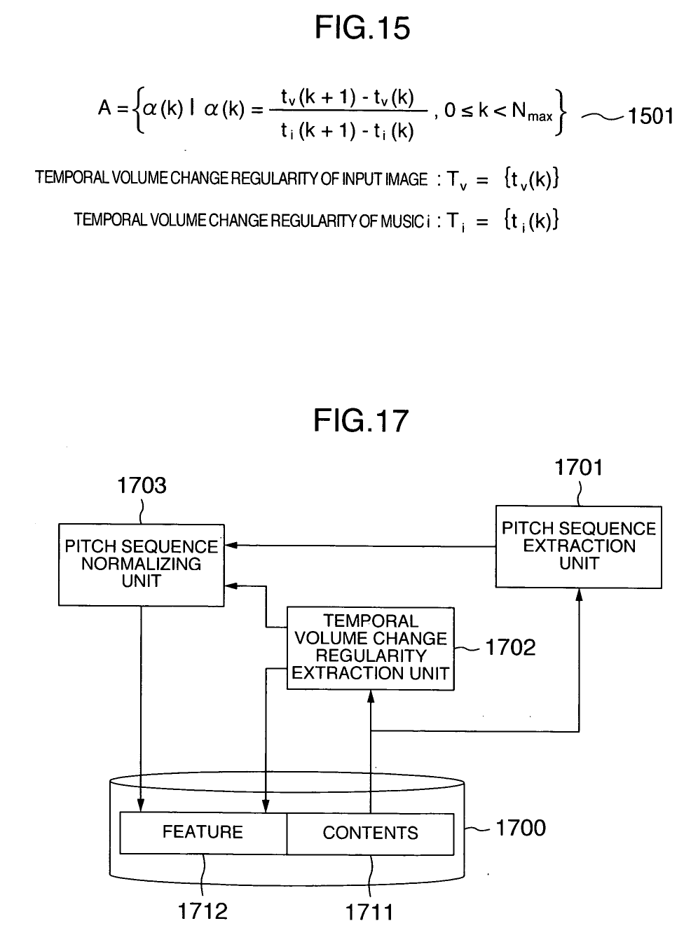

Next, the music information value adding system and method using the aforementioned music search method are explained with reference to FIGS. 13 to 15.

This system is configured of a processor (1301) for executing the search, a unit (1302) for inputting the video contents, a unit (1303) for outputting the conversion result, a memory (1310) for storing the program or temporarily holding the ongoing process and a music data base (1320). The memory (1310) has stored therein the music information value adding program (1311), the music search program (1312) and the music identity determining program (1313). Also, the music data base has stored therein a plurality of music (1322) and the features (1321) extracted from the particular music.

In performing the music information value adding process, first, the music (1322) accumulated in the music data base (1320) is retrieved (1400) using the music search program (1312) from the video contents input from the contents input unit (1302). The music can be retrieved using the music related information search method explained above with reference to FIGS. 9, 10 in the same manner as in the case where the music i itself is output as a search result in placed of the related information. Next, the temporal volume change regularity correction is made using the temporal volume change regularity of the input image and the feature amount of the music i (1401). Then, in accordance with the correction amount, the input image is expanded/compressed. In the case where the sound in the data base is added to the video contents, the sound information of the particular music portion of the image is replaced with the sound in the data base (1403). As a result, the sound of the played portion of the music program, for example, can be replaced with the music of CD quality in the data base, or in the case where the image is added to the sound in the data base, the dynamic image information of the particular music portion of the image is added to the sound in the data base (1404).

The temporal volume change regularity correction amount A is expressed by equation 1501. This indicates that in order that the interval between the kth peak and (k+1)th peak of the temporal volume change regularity may coincide with the music sound, the image is required to be expanded/compressed by α(k).

The music content added to the image or to which the image is added, as in this embodiment, is accumulated in advance in the music data base, or may be input from a recording medium such as a CD and accumulated in the archive on the internet.

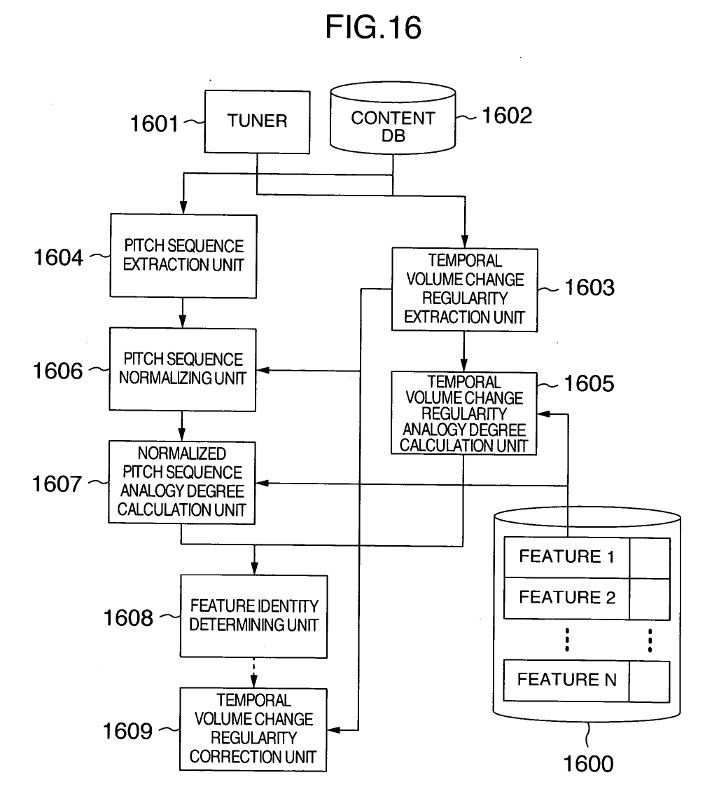

Next, the configuration and an example of the operation of a TV or a hard disk/DVD recorder according to the invention described above are explained with reference to FIG. 16.

This apparatus includes at least a tuner (1601) (for TV) or a content DB (1602) (for the hard disk/DVD recorder) such as a hard disk/DVD, a temporal video/volume change extraction unit (1603), a pitch sequence extraction unit (1604), a temporal volume change regularity analogy degree calculation unit (1605), a pitch sequence normalizing unit (1606), a normalized pitch sequence analogy degree calculation unit (1607), a feature identity determining unit (1608) and a music data base (1600). In the case where the apparatus has the music information value adding function, the temporal volume change regularity correction unit (1609) is also included.

The feature amount is extracted by the temporal volume change extraction unit (1603) and the pitch sequence extraction unit (1604) from the data including the image and the sound input from the tuner (1601) or the content DB (1602). Next, the temporal volume change regularity analogy degree is calculated by the temporal volume change regularity analogy degree calculation unit (1605) from the temporal volume change regularity feature amount extracted from the temporal volume change extraction unit (1603) and the feature amount accumulated in the music data base (1600). Also, the pitch sequence feature amount extracted by the pitch sequence extraction unit (1604) is converted to the normalized pitch sequence feature amount by the pitch sequence normalizing unit (1606) using the temporal volume change regularity feature amount. Next, from the normalized pitch sequence feature amount and the feature amount accumulated in the music data base (1600), the normalized pitch sequence analogy degree is calculated by the normalized pitch sequence analogy degree calculation unit (1607). Then, from the temporal volume change regularity analogy degree and the normalized pitch sequence analogy degree, the identity between the input image and the music corresponding to the feature accumulated in the music data base (1600) is determined from the temporal volume change regularity analogy degree and the normalized pitch sequence analogy degree. Further, the sound accumulated in the music data base (1600) is added to the input image. As an alternative, in the case where the input image is added to the sound accumulated in the music data base (1600), the input image is corrected by the temporal volume change regularity correction unit (1609) using the temporal volume change regularity feature amount extracted by the temporal volume change extraction unit (1603).

Next, an example of a feature generating unit for generating the feature accumulated in the music data base is explained with reference to FIG. 17.

From the contents (1711) such as music accumulated in the music data base (1700), the feature amount is extracted by the pitch sequence extraction unit (1701) and the temporal volume change extraction unit (1702). Next, the pitch sequence feature amount extracted by the pitch sequence extraction unit (1604) is converted to the normalized pitch sequence feature amount by the pitch sequence normalizing unit (1703) using the temporal volume change regularity feature amount extracted by the temporal volume change extraction unit (1702). The temporal volume change regularity feature amount extracted by the temporal volume change extraction unit (1702) and the normalized pitch sequence feature amount output from the pitch sequence normalizing unit (1703) are accumulated as a feature (1712) corresponding to the contents (1711) in the music data base (1700). While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. An information processing system comprising:
an input unit for inputting data including audio data;
an extraction module to extract feature information including pitch sequence information and temporal volume change regularity information from the audio data input by the input unit; and
a determining module to determine analogy degree between the feature information extracted by the extraction module and feature information of a predetermined audio data.

2. An information processing system according to claim 1, further comprising a pitch sequence normalizing module to normalize the pitch sequence information based on the temporal volume change regularity information;
wherein the determining module determines the analogy degree between the feature information including the temporal volume change regularity information and the normalized pitch sequence information normalized by the pitch sequence normalizing module and the feature information on the predetermined audio data.

3. An information processing system according to claim 1,
wherein the extraction module extracts the feature information of a predetermined portion of the audio data,
the system further comprising a music determining module to determine whether the predetermined portion is a music or not, based on the feature information extracted by the extraction module,
wherein the determining module determines the analogy degree for the predetermined portion determined as a music by the music determining module.

4. An information processing system according to claim 1, further comprising an output module to output the information on the analogy degree determined by the determining module.

5. An information processing system according to claim 1, further comprising an accumulation module to accumulate the data,
wherein the feature information of the predetermined audio data are accumulated in the accumulation module.

6. An information processing system according to claim 4, further comprising an accumulation module to accumulate the data,
wherein the feature information of the predetermined audio data are accumulated in the accumulation module.

7. An information processing system according to claim 5,
wherein a plurality of audio data are accumulated in the accumulation module,
the system further comprising a control module to control to replace the audio data input by the input module with the audio data accumulated in the accumulation module and to output the replaced audio data upon determination by the determining module that the feature information extracted by the extraction module and the feature information of the predetermined audio data are analogous to each other.

8. An information processing system according to claim 5,
wherein the information on a plurality of audio data are accumulated in the accumulation module,
the system further comprising a control module to control the output module to output the information on the audio data accumulated in the accumulation module upon determination by the determining module that the feature information extracted by the extraction module and the feature information of the predetermined audio data are analogous to each other.

9. An information processing system according to claim 5,
wherein a plurality of video data are accumulated in the accumulation module,
the system further comprising a control module whereby the video data corresponding to the audio data, among a plurality of the video data accumulated in the accumulation module, is added to the audio data input by the input module upon determination by the determining module that the feature information extracted by the extraction module and the feature information of the predetermined audio data are analogous to each other.

10. An information processing system according to claim 5,
wherein the information on a plurality of audio data are accumulated in the accumulation module,
the system further comprising a control module whereby the information on the audio data accumulated in the accumulation module is added to the audio data input by the input module upon determination by the determining module that the feature information extracted by the extraction module and the feature information of the predetermined audio data are analogous to each other.

11. An information processing system according to claim 5, further comprising an expansion/compression module to expand/compress at least selected one of the video data and the audio data input by the input module and/or at least selected one of the video data and the audio data accumulated in the accumulation module.

12. An information processing system according to claim 9, further comprising an expansion/compression module to expand/compress at least selected one of the video data accumulated in the accumulation module and the audio data input by the input module.

13. An information processing system according to claim 5,
wherein the data accumulated in the accumulation module is input by the input module.

14. An information processing system comprising:
an input unit for inputting content data including audio data;
an extraction module to extract feature information including pitch sequence information and temporal volume change regularity information from the audio data included in the content data; and
a data accumulation module;
wherein the feature information extracted by the extraction module are accumulated by the accumulation module as data corresponding to the content data input by the input unit.

15. An information processing system according to claim 14, further comprising a pitch sequence normalizing module to normalize the pitch sequence information based on the temporal volume change regularity information,
wherein the accumulation module has accumulated therein the feature information including the temporal volume change regularity information and the normalized pitch sequence information normalized by the pitch sequence normalizing module.

16. An information processing system according to claim 14,
wherein the extraction module extracts the feature information from the content data input to the input unit after being accumulated in the accumulation module.

17. An information processing method comprising the steps of:
inputting data including audio data;
extracting feature information including pitch sequence information and temporal volume change regularity information from the audio data input in the input step; and
determining analogy degree between the feature information extracted in the extraction step and feature information of a predetermined audio data.
